(19) United States
(12) Patent Application Publication
(10) Pub. No.: US 2024/0037682 A1
(43) Pub. Date: Feb. 1, 2024

(54) SYSTEM AND METHOD FOR THE ANALYSIS OF DEPOSITION DATA

(71) Applicant: Cloud Court Inc., Minneapolis, MN (US)

(72) Inventors: Milena Higgins, Vadnais Heights, MN (US); Michael D. Okerlund, Minneapolis, MN (US)

(21) Appl. No.: 18/226,904

(22) Filed: Jul. 27, 2023

Related U.S. Application Data
(60) Provisional application No. 63/392,727, filed on Jul. 27, 2022.
(60) Provisional application No. 63/393,159, filed on Jul. 28, 2022.
(60) Provisional application No. 63/409,612, filed on Sep. 23, 2022.
(60) Provisional application No. 63/447,273, filed on Feb. 21, 2023.

(51) Int. Cl. G06Q 50/18

(52) U.S. Cl. CPC G06Q 50/18

(57) ABSTRACT

Methods, computer systems, and apparatus, including computer programs encoded on computer storage media, for data extraction and analysis from diarized legal transcripts. The system obtains a transcript of a legal interaction, identifies its format, and selectively identifies and extracts testimony and non-testimony data therefrom. The system stores subsets of testimony and non-testimony data for analysis, submits data to an analysis module or engine, then exports the resulting analysis data which is associated with one or more parts of the transcript, such as by page and line number. Testimony and testimony analysis data may then be displayed visually or temporally using a user interface and subsets of the testimony data across multiple transcripts may be selectively displayed or exported via reports.

The present application claims the benefit of U.S. Provisional Application 63/392,727 titled “Testimony Intelligence Repository with Interactive Dashboard,” filed Jul. 27, 2022, U.S. Provisional Application 63/393,159 titled “Testimony Intelligence Repository with Interactive Dashboard” filed Jul. 28, 2022, U.S. Provisional Application 63/409,612 titled “Testimony Intelligence Repository with Interactive Dashboard” filed Sep. 23, 2022, and U.S. Provisional Application 63/447,273 titled “SYSTEM AND METHOD FOR THE GENERATION TESTIMONY INTELLIGENCE” filed Feb. 21, 2023, each of which is incorporated herein by reference in its entirety.

### BACKGROUND

This disclosure is directed to depositions or trial proceedings during which lawyers question witnesses and witnesses provide testimony in response to those questions. Typically, a deposition or trial proceeding is attended by a court reporter or stenographer that records the deposition along with other information relevant to the case. In the case of deposition testimony, there is only one witness per deposition. In the context of trial testimony, however, a single transcript can contain the testimony of multiple witnesses. Trial transcripts can also contain discussions on the record between counsel for both parties and/or the judge, arguments on motion practice, sidebar colloquies with the court, opening and closing statements and the like.

For individuals participating in a deposition (whether taking the deposition or defending the witness, or serving as a witness) the process of preparing and participating can be a atime-consuming process. And at the conclusion of the deposition, it can be time consuming for an individual in attendance to convey what occurred during that deposition to other members of the case team and to the client. Furthermore, people miss things, including important things, that occurred during the deposition, either because they were distracted while others were talking or because what someone was saying didn't seem important at the time (though it may become critically important later). If one wasn't at the deposition, then the only way to know what occurred is to read the transcript. But reading a 7-hour deposition (for example) is time consuming.

Reading a partial summary of that same deposition often doesn't convey all the information that needs to be conveyed to the case team. In short, everyone needs to know what's in testimony, but few people have time to actually read it and few clients are willing to pay more than one member of a trial team to read that transcript after the deposition occurred. What would be better would be if someone could distill down key things (and the minutia) that occurred during a deposition in the form of a summary or synopsis and convey what was discussed and what occurred in objective terms. It would also be beneficial to allow individuals to dive into parts of testimony that contain information of interest, including diving into aggregate testimony.

### SUMMARY

This disclosure is directed to systems, methods, and techniques that enable improvements in analyzing and processing legal proceedings, including transcripts that reflect statements made during the course of one or more legal proceedings. For example, a method is described. The method includes receiving data associated with a legal proceeding, wherein the data includes at least one transcript that reflects words spoken by participants during the course of the legal proceeding. The method further includes separating the data into a plurality of segments that each comprise data associated with at least one of: a question asked during the legal proceeding, an answer given in response to the question asked during the legal proceeding, an objection raised during the legal proceeding, and an argument raised during the legal proceeding. The method further includes analyzing the plurality of segments, which includes assigning at least one participant characteristic to the segments based on an identity of the participant associated with the segment, and assigning at least one content characteristic to the segments based on the content associated with the segment. The method further includes providing, to a user via an output device, a user interface that enables the user to sort the plurality of segments based on the assigned at least one participant characteristic and the assigned at least one content characteristic.

As another example, a system is described. The system includes a segmentation engine that receives data associated with a legal proceeding, wherein the data includes at least one transcript that reflects words spoken by participants during the course of the legal proceeding and separates the data into a plurality of segments that each comprise data associated with at least one of: a question asked during the legal proceeding, an answer given in response to the question asked during the legal proceeding, an objection raised during the legal proceeding, and an argument raised during the legal proceeding. The system further includes an analysis engine that analyzes analyzing the plurality of segments. The analysis engine includes an identity characteristic engine that assigns at least one participant characteristic to the segments based on an identity of the a participant associated with the segment, and a content characteristic engine that assigns at least one content characteristic to the segments based on the content associated with the segment. The system further includes a user interface that enables the user to sort the plurality of segments based on the assigned at least one participant characteristic and the assigned at least one content characteristic

As another example, a computer-readable medium is described. The computer-readable medium stores instructions that, when executed by a processor, cause a computing device to receive data associated with a legal proceeding, wherein the data includes at least one transcript that reflects words spoken by participants during the course of the legal proceeding. The instructions further cause the computing device to separate the data into a plurality of segments that each comprise data associated with at least one of: a question asked during the legal proceeding, an answer given in response to the question asked during the legal proceeding, an objection raised during the legal proceeding, and an argument raised during the legal proceeding. The instructions further cause the computing device to analyze the plurality of segments, including to assign at least one participant characteristic to the segments based on an identity of the a participant associated with the segment, and assign at least one content characteristic to the segments based on the content associated with the segment. The instructions further cause the computing device to provide, to a user via an output device, a user interface that enables the user to sort the plurality of segments based on the assigned at least one participant characteristic and the assigned at least one content characteristic.

This specification describes a system and associated methods for generating and/or obtaining transcripts consisting of deposition and trial records transcripts; identifying, extracting and/or tagging text and other classes of data in those records; sorting those records, such as by page number or other sequential format; cleaning the files of unwanted data; splitting larger files into sections (if desired); extracting certain classes of data from testimony while avoiding undesired data (or removing such data later); organizing that data; conducting word or text or character counts; inputting testimony data into an analysis engine, such as a topic extraction engine or a narrative summary engine or an objection identification engine or other engine; receiving output data, mapping output data, if desired, relative to page numbers in a transcript; depicting and/or summarizing that data visually and/or narratively, including in certain embodiments by layering different classes of data over other classes of data. For example, by identifying witnesses that not only address the same topics, but identifying that testimony where those two (or more) topics are discussed at the same time or in close proximity with each other.

By utilizing the system and method herein, one can provide a detailed synopsis of testimony data in order to share critical information with individuals that did not personally participate in a deposition or trial, and render data from those transcripts in a more clear, concise and understandable format.

This specification also describes systems and methods for generating metrics and predicting other aspects of the deposition. In accordance with one or more aspects of the invention and corresponding disclosure thereof, various features are described in connection with utilizing the content of existing deposition and trial transcripts, including the speech of a deponent or witness or attorney uttered during a legal proceeding, and utilizing the contents of those preexisting transcripts as input into an analytics engine that will predict in advance what an attorney is going to ask a witness in a future deposition as well as, inter alia, predictions regarding other aspects of the deposition, such as length of deposition, documents referenced or introduced, methods of questioning, the likelihood of “objectionable” questions being asked, among others.

In an embodiment, these predictions take the form of a predictive deposition transcript, containing predicted questions or classes of questions on topics, which can be reviewed by a witness in advance so that they know what they should expect at the future deposition. In another embodiment, these predictions take the form or an attorney or law firm dossier, setting forth the habits, tactics and statistics relevant to a particular attorney or firm.

In another embodiment, predictions and metrics can be used to anticipate other facts and factors related to an upcoming deposition. In some embodiments, the system utilizes the contents of deposition transcripts taken in similar matters by an attorney that is known or believed is likely to take a future deposition, whether in the same or a different matter. As will be recognized by one of skill in the art, these same methods can be utilized in advance of other types of testimony as well.

The enclosed system and method further disclose the organization of testimony using a taxonomy of witnesses and a taxonomy of topics to facilitate searching through a volume of testimony to identify exactly what is needed and avoid having to read text that isn't relevant. For example, traditional depositions contain a limited index of single words, as opposed to multi-word terms and/or phrases. In a case involving gold, for example, a witness could testify about gold, gold bars, gold coins, gold bullion, etc. If someone wanted to find a reference to just gold bars and not gold coins, however, then that would be difficult to do in the context of a traditional deposition transcript, which only shows the location of occurrences of the word “gold.” In the described system and method, however, one would be able to identify very quickly only testimony related to gold coins and avoid testimony related to other gold topics that are not of interest. Such a system and method would save an inordinate amount of time and at today's litigation attorney billing rates, an inordinate amount of money.

### BRIEF DESCRIPTION OF THE DRAWINGS

FIG. 2 is a block diagram that depicts a legal proceeding analysis system according to one or more aspects of this disclosure.

FIG. 3 is a flow chart diagram that depicts a method of processing data associated with a legal proceeding according to one or more aspects of this disclosure.

### DETAILED DESCRIPTION

Below is an exemplar process diagram. It sets forth steps and methods for facilitating the generation and/or acquisition of testimonial files (testimonial files being broadly construed to including both transcripts of actual testimony (e.g., deposition transcripts) as well as transcripts containing a combination of testimony and attorney argument or advocacy (e.g., trial transcripts, which often contain both testimony and attorney argument and advocacy and judicial commentary) or transcripts not involving testimony but involving attorney oral advocacy (arguments associated with motion practice, voir dire, jury instructions, etc.); ingesting and storing those files; extracting text and other desired classes of data from the files and storing that data; performing sorting functions on extracted information; cleaning files; splitting files; preparing the files for analysis modules (e.g., topic extraction modules; narrative synopsis modules; sentiment analysis modules, etc.,); analyzing said files; receiving outputs from one or more analysis modules; storing and/or mapping the resulting data; loading data into a database; or rendering the data accessible to a data visualization module (e.g., Microsoft Power BI or Tableau), whereupon the data or portions of the data may be displayed, examined, compared, analyzed and/or exported, as well as used in other ways.

In an embodiment, the process may include the generation of testimony utilizing existing methods known in the art, for example, the creation of a transcript by transcriptionists or court reporters. In an embodiment, this may be accomplished through the utilization of stenograph hardware and software elements, including CAT software installed on a local steno computer. In an embodiment, the CAT software module “reads” the shorthand strokes entered off the steno machine (said strokes reflecting the, in an embodiment, questions, objections and witness answers, among other things). In an embodiment, the transcription system may employ a translates the shorthand strokes per the Specialized Dictionary. The steno machine can be connected via wireless or wired connection to the Local Steno Computer. The Local Steno Computer can be connected via a wireless or wired connection to one or more Local Systems (wired or wireless or via a network) and/or one or more Remote Systems either via a network connection via the Local Steno Computer or via a (not depicted) wired or networked connection from a local system. The deposition may be stored in a repository, e.g., in repositories of the kind employed by national court reporting agencies storing transcripts from multiple court reporters and for numerous clients (law firms, corporations, and the like).

In an alternative embodiment, the transcripts may be generated by any other method known in the art, including through speech to text services, among others. Regardless of the source of the transcripts, the transcripts themselves will undergo additional processing. Depending on the type and condition of the data, one or more of these steps may be omitted or addressed in an order different than shown below. Below are steps that may be taken, in one embodiment, to obtain one or more traditional transcripts and process them, submit them to an analysis module (in this instance a topic extraction module via the exemplar main.py code, an exemplar of which is detailed herein), obtain output files (the type and contents dependent on the modules utilized) and the utilization of same, including to represent the data visually and analyze it in various ways.

As an introductory step, and in an embodiment, one or more transcripts (e.g., deposition or trial transcript, hearing transcript, or other transcript—e.g., including attorney argument, motion practice, etc.) is acquired. Files comprising audio or audiovisual data of testimony may also be ingested.

Typically, transcripts may be forwarded from one or more remote storage locations maintained by law firms, corporations, court reporting agencies, and the like. In an embodiment, these acquired files (transcripts or audio or audio/visual files) may be stored in a local environment or a dedicated space in a cloud environment (e.g., AWS, Azure, etc.), or a shared drive. Other suitable storage spaces may be utilized. The files may take a wide variety of forms, as set forth infra.

After the files are acquired, then text and other alphanumeric data is extracted from them using any one of a variety of methods. The methods employed will be appropriate to the file type, as is recognized by one of skill in the art.

Text may be extracted from a single file and stored in an ASCII file, in one embodiment. In an embodiment, text may be extracted from multiple files of the same type and stored in an ASCII file. Other file types may be utilized.

In an embodiment, text extracted from one or more files may be extracted and stored in two or more separate files, with text representing speech stored separately from text representing, for example, deposition page numbers, line numbers, header and footer information, deposition index or caption information, or other information.

In an embodiment, a file conversion module may be utilized to operate on multiple files representing multiple depositions, which are not in a uniform format and convert them to a desired format in advance of extracting all or a portion of their contents then storing them.

In some instances, such as with the case of audio files or audio/visual files, additional processing may be required. For example, if the file is an audio file of a deposition (also discussed infra), a speech-to-text module may be utilized to convert the audio into text in a desired file type (e.g., ASCII text, webVTT, JSON). In an embodiment, a diarization module, that is, a module capable of identifying the speech of one or more individuals and attributing that speech to those one or more individuals in a written manner may be employed.

In some instances, where the file is of a type that contains audio and visual data (e.g., from a videographer), that part of the data representing audio data may be obtained from that file and submitted to the speech-to-text module and/or diarization module.

Regardless of the file type and the preprocessing required (if needed), the text in the file (or extracted from the audio or audio/visual file) may be copied and/or stored in one or more files (e.g., text representing speech in one file and, in an embodiment, other data stored in another file).

In an embodiment where classes of data are extracted and stored in two or more separate files, the files or folders in which they are stored may employ a naming convention or be appended with metadata or be augmented with additional data which may be used to later track the files and/or folders such that they may be recognized as coming from the same deposition or same original file. Any method may be utilized.

Files containing text and/or other data may undergo additional processing, preparation and analysis. Examples of that preparation, processing and/or analysis are set forth in this section, as well as in other sections addressing preparation (e.g., CleanFile, SplitFile_Main, Word_Count or others.). Other and/or additional preparation steps may be employed, as desired or required in other embodiments.

In one embodiment, the system and method analyzes one or more files and determines whether their contents fall into a recognized format (transcription formatting varying meaningfully across a number of formats), or if they possess or do not possess recognized classes of content. In an embodiment, and depending on the format and/or contents, the system may subject them to different processes appropriate to their format or content to make them compatible for eventual submission to one or more analysis modules, as set forth herein (e.g., topic extraction, narrative summary, sentiment analysis, etc.).

In an embodiment, the text below is exemplar code for preparing the file(s) in advance of additional processing and for use by the system and method. These are exemplar preparation steps; other preparation steps may be employed as necessary, depending on the nature and contents of the file, and the desired output and use.

```
# Counts words in each file in a folder specified by user
# Also determines PageNo format for later mapping pages to extracted topics
# Logs filename, word count, and pageno format into a json file
# Moves file to folder corresponding to the PageNoFormat
import os
import shutil # used for moving files to a different folder
import json
from datetime import datetime
from pathlib import Path
import re
# Loop through files in the Inputs folder
# List wordcount for all files
# Have user provide the input folder path
# Define file and folder locations
basepath = input(f“Folder path where the intput text files are: ”) + ‘/’
batch_path = input(f“Batch path or Project path, if different from above: ”)
# Determine page number format in text file, options below
#regex0 = r“\hat{ }Page (\d+)” # original Page N regex, modified by the one below
regex1 = r“Page\s+(\d+)” # right or left justified “Page nnn” format, with single or multiple spaces
(or tab)
regex2 = r“\hat{ }\s{3,}(\d+)\s$” # right justified digits only
regex3 = r“\hat{ }(\d+)$” # left justified digits only
# data for the log
log_data = [ ]
today = datetime.today( ).strftime(‘%Y%m%d_%H%M’)
log_file = ‘file_log_’ + today + ‘.json’
# Initialize variables
wc = 0
pg_fmt = “”
pg_format = “”
newpath = basepath
# Functions
def count_words(file) −> int( ):
  data = file.read( )
  words = data.split( )
  word_count = len(words)
  return word_count
def page_format(file) −> str:
  lines = file.readlines(1500)
  global newpath #TODO need to learn more about local vs global variables
  # Initialize variables
  pg_format = “”
  newpath = basepath
  # for each line read look for page format
  for line in lines:
    match1 = re.search(regex1, line)
    match2 = re.search(regex2, line)
    match3 = re.search(regex3, line)
    # Determine page format
    if match1:
      pg_format = “Page nnn”
      newpath = batch_path + “PageN/”
    elif match2:
      pg_format = “Right justified nnn”
      newpath = batch_path + “RightJnnn/”
    elif match3:
      pg_format = “Left justified nnn”
      newpath = batch_path + “LeftJnnn/”
    else:
      continue
  return pg_format
# Loop through files in the specified folder (basepath)
for entry in os.listdir(basepath):
  if os.path.isfile(os.path.join(basepath, entry)):
    with open((basepath + entry), “rt”, encoding=‘ISO-8859-1’) as f:
      wc = count_words(f)
      f.seek(0)
      pg_fmt = page_format(f)
      #print(f“New path: {newpath}; file is: {entry}”)
      file_info = {
        ‘folder’: basepath,
        ‘filename’: entry,
        ‘word count’: wc,
        ‘page format’: pg_fmt
      }
      log_data.append(file_info)
    shutil.move(basepath + entry, newpath + entry)
with open(batch_path + log_file, ‘w’) as json_file:
  json.dump(log_data, json_file, indent=2)
```

In an embodiment, the files may be “cleaned” to eliminate undesired or useless data and/or further prepare the data for utilization by the system and method. The step of cleaning may be undertaken as part of or prior to file preparation. This is sometimes referred to as parsing data to those skilled in the art.

Below are exemplar steps and code for accomplishing this in an exemplar embodiment, as well as code which determines formatting, information logging, and file organization, among other steps. Other steps and other forms of cleaning may be employed depending, among other things, on the contents of the data, etc.

```
# Does some initial file cleanup (e.g., removing headers and footers)
# Each text phrase to be removed is specified as input when the script is run
# When done, user specifies ‘None’ as text to be removed to end the script
import os
basepath = “/Users/milenahiggins/Library/CloudStorage/OneDrive-SharedLibraries-
cloudcourtinc.com/Customers - Documents/Project/TextFiles/Batch2.7/”
print(f“If at any point you need to exit without saving, press CTRL+C (\hat{ }C)”)
filein = input(“Pls enter the file name: ”)
fileout = basepath + “Clean/” + input(“Enter the new file name: ”)
file = open((basepath + filein), “rt”, encoding=‘ISO-8859-1’)
data = file.read( )
wc = len(data.split( ))
print(wc, “words in ”, filein)
file.close( )
# Input Text to be removed and replaced (one line at a time)
Text2remove = input(“Enter text to be removed: ”)
ReplacementTxt = input(“Enter replacement text: ”)
newdata = data.replace(Text2remove, ReplacementTxt)
# While answer is not “None” keep replacing stuff
while Text2remove != “None”:
  newdata = newdata.replace(Text2remove, ReplacementTxt)
  f = open(fileout, ‘w’, encoding=‘ISO-8859-1’)
  f.write(newdata)
  Text2remove = input(“Enter text to be removed (enter ‘None’ if done): ”)
f.close( )
new_wc = len(newdata.split( ))
print(new_wc, “words in ”, fileout)
```

The above exemplar code aside, cleaning the data can be accomplished in other ways as well, via a data cleaning module, which takes a plurality of steps, demonstrated here in context of an exemplar structured JSON format:

```
import json
# Load the JSON data from a file
with open(‘data.json’) as json_file:
  data = json.load(json_file)
# Clean up the data by removing any invalid or inconsistent records
cleaned_data = [
for record in data:
  # Check if the required fields are present in the record
  if all(field in record for field in [‘field1’, ‘field2’, ‘field3’]):
    # Perform any additional cleaning or validation on the record
    if isinstance(record[‘field1’], int) and record[‘field1’] > 0:
      cleaned_data.append(record)
# Save the cleaned data back to a file
with open(‘cleaned_data.json’, ‘w’) as json_file:
  json.dump(cleaned_data, json_file, indent=4)
```

In an embodiment, this exemplar code assumes that the input file, data.json, contains a list of dictionaries, where each dictionary represents a record. The example checks if each record contains all of the required fields, and performs additional cleaning or validation on the data if necessary. Finally, the cleaned data is saved to a new file, cleaned_data.json.

In other embodiments, the code may check for different fields, perform different types of validation, and/or handle errors in alternative ways. Other methods to clean or parse the data may be employed without departing from the scope of the invention.

In an embodiment, once the data is prepared, it can be loaded. In an alternative embodiment, additional steps may be taken prior to loading the data.

Data can be loaded into a database using various methods, depending on the database and the format of the data. For example, the LOAD DATA or COPY command in a relational database can be used, or the mongoimport tool in MongoDB. These are examplary and are not exhaustive. Other methods may be employed without departing from the scope of the invention, especially if the data is in a proprietary or unusual format.

In an embodiment, an additional step may be added to verify that the data was loaded correctly and that all the relationships between the tables are intact. This can be done by running queries or using tools provided by the database technology employed.

In an embodiment, data access can be optimized by creating indexes, partitioning the data, and tuning the configuration parameters. Note that the exact steps and details for ingesting files into a database will vary depending on the specific database technology and the format of the data.

In an embodiment, additional steps may be taken to further prepare the contents of a file or data prior to submitting it to an analysis engine, such as a topic extraction engine, a sentiment analysis engine, or an engine utilized to synopsize text into a shorter summary. For example, in one embodiment, and prior to submitting data to a topic extraction module, data may be split into chunks prior to analysis. For example, a topic extraction engine or module may have limitations on the amount of data that can be processed by the module at any one time. Where the data to be analyzed exceeds that maximum threshold, this additional step of cutting the data into chunks that fall below that maximum threshold may be required. In an embodiment, the chunks are then submitted for processing via an analysis engine (see infra).

In one embodiment, steps may be taken to ensure that when data from, for example, a complete deposition, is split into multiple (and smaller) segments of data in anticipation of processing, then additional steps may be taken to ensure that the resulting output can be reassembled to reflect the same order. For example, a deposition file may be split into four smaller data segments prior to being submitted to a topic extraction or sentiment analysis module. In various embodiments, the smaller data segments may be stored in separate folders, stored as separate files, be appended with metadata or take any other step necessary to identify the larger set of data from which the smaller data segment is a part, and identify in which sequential order that data segment falls, such that the resulting output, which may also be in separate files or otherwise segregated from each other, may be reassembled or ordered in a database. As will be appreciated by one skilled in the art, that this may be accomplished in numerous ways, including by adding additional information to the data segments to be analyzed, adding information to the file name for the segments of data, placing the data in folders with naming conventions, appending metadata to the data segments, or any other method.

In one embodiment, exemplar code such as that set forth below, may be employed to accomplish one of more of these steps.

```
# Splits file into chunks based on MAX number of words allowed in one
chunk
# Saves the file chunks in a folder called CleanChunks
# TODO fix last page of Document skipping
from lib.readLines import Document
from lib.readLines import Page
import os
prompt = “−> ”
basepath = input(f“Enter the project folder path: {prompt}”)
#basepath = “/Users/milenahiggins/mlab/TEST_project”
#filein = input(f“Pls enter the name of the file to be split: {prompt}”)
#textfiles_path = basepath + “/TextFiles/”
#textfiles_path = basepath + “/TextFiles/Batch2/LeftJnnn/” # Alternate
Left Justified page number formatted docs
textfiles_path = basepath + “/TextFiles/Batch2.7/PageN/” # Alternate
page no formatted docs
fileout_path = basepath + “/CleanChunks/Batch PageN/”
MAX_WORDS_PER_CHUNK = 13900
total_count = 0
# Loop through files in the specified folder (textfiles_path)
for entry in os.listdir(textfiles_path):
  if os.path.isfile(os.path.join(textfiles_path, entry)):
    # Initialize the file count and word count
    word_count = 0
    file_count = 0
    # Initialize the output file
    output_file = None
    if entry != “.DS_Store”:
      filein = entry
      # Working files for this run
      filetxt = textfiles_path + filein
      basename = filein.split(“.txt”)[0]
      fileout = fileout_path + basename + “_clean” + str(file_count) +
      “.txt”
      doc_text = Document(filetxt)
      no_of_pages = len(doc_text.pages) + 1
      print(f“{filein} is {no_of_pages} pages”)
      for page in doc_text.pages:
        if output_file is None:
          # Open the output file
          output_file = open(fileout, ‘w’)
          # Add the current page to the output file
          output_file.write(page.full_page_str( ))
          word_count += page.word_count( )
        else:
          # Get word count for current page
          thispg_wordct = page.word_count( )
          # Increment running word count
          word_count += page.word_count( )
          # Check if word threshold has been reached
          if word_count >= MAX_WORDS_PER_CHUNK:
            # Close the output file
            output_file.close( )
            print(f“{fileout} done”) # Temporary sanity
check
            # Increment the file count
            file_count += 1
            # Reset the word count, starting with current
page
            word_count = thispg_wordct
            # Update fileout to new chunk file
            fileout = fileout_path + basename + “_clean” +
str(file_count) + “.txt”
            output_file = open(fileout, ‘w’)
            output_file.write(page.full_page_str( ))
          else:
            # If word count is below MAX threshold
            # Add the current page to the output file
            output_file.write(page.full_page_str( ))
        output_file.close( )
        total_count += 1
# print(f“{fileout} done”) # Temporary sanity check
    continue
print(f“Splitting complete: {total_count} files created in \n
{fileout_path}”)
```

In an embodiment, the system may employ a method to check files or data after one or more preparatory steps are employed to ensure that the resulting data is suitable for ingestion into an analysis engine. Various checks may be employed, including a “word count” check to ensure that segments of data to be submitted to an analysis engine comply with the requirements of that engine.

As stated herein, in some embodiments, segments of data containing text may be larger than desired and may be split into segments in advance of processing, for example in advance of operations performed by a topic extraction module or a narrative synopsis module. In such a case, the system and method may count the number of words or characters or data in a file and then determine whether it falls within or outside of desired parameters. Below is exemplar code that may be utilized in one embodiment.

```
# Counts words in each file in a folder specified by user
# If word count is below threshold, moves file to RevInputs folder
import os
import shutil # used for moving files to a different folder
import logging
import datetime
# Loop through files in the Inputs or Text Files folder
# List wordcount for all files in that folder
# Set up folders for this run
basepath = input(f“What is the PROJECT path: ”) + ‘/’
cc_folder = input(f“Which folder(s) are the text files in (‘/’ will be
added): ”)
cc_path = basepath + “/” + cc_folder + “/”
answer = input(“Confirm, files will be moved to RevInputs (Y/N): ”)
if answer == “Y”:
  newpath = basepath + ‘/RevInputs/’
elif answer == “N”:
  newpath = input(f“Enter new path: ”) + ‘/’
else:
  newpath = basepath + ‘/RevInputs/’
# Create logger
logging.basicConfig(filename = basepath + “/Extras/Issues.log”, level =
logging.DEBUG)
logger = logging.getLogger( )
# Log time of this run
today = datetime.datetime.now( )
logger.info(f“\nGibson Log for {today}; wordCount.py”)
log_format = “%(asctime)s::%(levelname)s:%(name)s::”\
      “%(filename)s::%(lineno)d::%(message)s”
logging.basicConfig(level=‘DEBUG’, format=log_format)
counter = 0
# Loop through files in the specified folder
for entry in os.listdir(cc_path):
  if os.path.isfile(os.path.join(cc_path, entry)):
    # Count the number of words in each file
    file = open((cc_path + entry), “rt”, encoding=‘ISO-8859-1’)
    data = file.read( )
    words = data.split( )
    wc = len(words)
    file.close( )
    # If wordcount < 14,000, move to RevInputs folder for text extraction
    if wc <= 14000:
      # call RevSubmit
      logger.info(f“{wc} words; \t File moved to RevInputs: \t {entry}”)
      shutil.move(cc_path + entry, newpath + entry)
      counter += 1
    else:
      logger.info(f“{wc} words; \t File is too large: \t\t {entry}”)
logger.info(f“Done: Moved {counter} files to {newpath}”)
print(f“Done: Moved {counter} files to {newpath}”)
```

This is an example of a pre-submission data check, this one focusing on compliance with word count requirements for a topic extraction engine/module. Other pre-submission checks may be employed in other embodiments in view of the requirements of other engines/modules prior to the submission of data to those engines.

The system and method may take data obtained from deposition or testimony, extract and prepare it as set forth on one or more of the steps set forth within, and then submit all or a portion of that data to an analysis engine or module. As noted, the system and method may employ one or more such modules (topic extraction, sentiment analysis, narrative summary, objection analysis, etc.). These modules may be internal or external modules accessed via an API. Each module/engine may have its own requirements for the submission of data.

In an embodiment, and as stated, the system and method may examine the contents of a file or data to determine if it falls inside or outside of desired parameters. If it falls outside of said parameters, then in an embodiment the file/data may be flagged for review or be further processed. In an embodiment, if it falls inside the desired parameters, then steps will be taken to send the data to an operations module/engine, such as a topic extraction module.

Note that in an embodiment, data may be submitted to the analysis engine in batches, and a system of the kind known in the art set up to monitor the successful or unsuccessful submission of those batches so that data that is not successfully processed or is rejected for any reason may be identified and resubmitted including after any errors have been identified and corrected.

Below is an example of code that may be utilized to submit testimony data to an exemplar analysis module/engine via and API, in this case a topic extract engine. Other types of analysis modules/engines may be utilized.

```
# Submits text extraction files in a specified folder to the topic extraction API
# First checks if word counts is under the Max limit, if so sends API request
import requests
import os
import json
import datetime
import time
import shutil
import logging
basepath = input(f“Enter the PROJECT path (files will be moved from RevInputs): ”) + “/”
inputs_path = basepath + “/RevInputs/”
batch_name = input(f“Enter Batch name to be sent as metadata to Rev along with the filename: ”)
# Create logger
logging.basicConfig(filename = basepath + “/Extras/Issues.log”, level = logging.DEBUG)
logger = logging.getLogger( )
# Log time of this run
today = datetime.datetime.now( )
logger.info(f“\nGibson Log for {today}; main.py”)
log_format = “%(asctime)s::%(levelname)s::%(name)s::”\
      “%(filename)s::%(lineno)d:%(message)s”
logging.basicConfig(level=‘DEBUG’, format=log_format)
def Submit2Rev(filename, data):
  RevTkn = str(
    “02i8z1pUJcHNQ21ubEZQlHJ3tTvnPTtTUdbXV_spjIlAk3zX4ToNGPMEvVnsBwbs4aA_-
dSjCeChRRNKXSH6EGm-lN8lw”)
  # Rev code for submitting a Topic Extraction Job (Plain Text Submission)
  url = “https://api.rev.ai/topic_extraction/v1/jobs”
  payload = {
    “language”: “en”,
    “metadata”: filename,
    “delete_after_seconds”: 1000000,
    “text”: data
  }
  headers = {
    “Content-Type”: “application/json”,
    “Authorization”: “Bearer ”+RevTkn
  }
  response = requests.post(url, json=payload, headers=headers)
  job_data = response.json( )
  return job_data
# Initialize counters
counter = 0
batch = 1
master_count = 0
submitted_count = 0
# Loop through files in the specified folder (basepath/RevInputs/)
# List wordcount for all files
for entry in os.listdir(inputs_path):
  counter += 1
  master_count += 1
  if counter == 17:
    # Wait 15 minutes
    print(f“Taking a break at {datetime.datetime.now( )}, back in about 15 minutes. Batch {batch},
counter {counter}, submitted count: {submitted_count}”)
    logger.info(f“Taking a break at {datetime.datetime.now( )}, back in about 15 minutes. Batch
{batch}, counter {counter}, submitted count: {submitted_count}”)
    # TEMP: wait for user to indicate first batch of jobs is complete before submitting second batch
    input(“Confirm once jobs have completed processing in Rev.ai (Y/N): ”)
    #time.sleep(960)
    # reset counter
    counter = 0
    batch += 1
  if os.path.isfile(os.path.join(inputs_path, entry)):
    filename = entry
    if “.DS_Stor” in str(filename):
      continue
    else:
      # Count the number of words in each file
      file = open((inputs_path + entry), “rt”, encoding=‘ISO-8859-1’)
      data = file.read( )
      words = data.split( )
      wc = len(words)
      file.close( )
      # If wordcount < 14,000, submit job to Rev
      if wc < 14000:
        filename2 = batch_name + “_” + filename
        this_job = Submit2Rev(filename2, data)
        submitted_count += 1
        logger.info(f“{entry} submitted to Rev \t\t {batch}, {submitted_count}”)
        shutil.move(inputs_path + entry, inputs_path + “/Processing/” + entry)
        with open(inputs_path + “Submitted/” + entry + “.json”, ‘w’) as f1:
          json.dump(this_job, f1, indent=2)
      else:
        print(f“{wc}, {entry} ----------> File is too large”)
        logger.info(f“{wc}, {entry} ----------> File is too large”)
    continue
# TODO pass that counter to the RevJobs function
# so we get only those jobs we just submitted in the ExtractionJobs file
print(f“Files processed; {submitted_count} jobs submitted to Rev”)
logger.info(f“Files processed; {submitted_count} jobs submitted to Rev”)
```

Again, this is an exemplar of one embodiment in one type of analysis module or engine. Other engines/modules may be utilized without departing from the scope on the invention.

### Training and Reference Data for Analysis Engines/Modules

In an embodiment, one or more testimony analysis modules or engines may be enhanced through the utilization of training data, which provides data to that module in advance of the submission of testimony data, to prepare it to provide more accurate or desirable results.

In an embodiment, a feature of the system is related to training testimony analysis modules (e.g. topic extraction, narrative summary, etc.) to more accurately perform their designated functions. In an embodiment, for example, a topic extraction module may be trained utilizing, in whole or in part, data, including but not limited to data from a specific case or a class or classes of litigation.

In an embodiment, said modules utilize various categories of data and subsets of that data to train the system to accurately identify and extract topics or summarize testimony. Several applicable categories of data that may be utilized by the system, including various classes of evidence produced between the parties, eDiscovery, and work product, pleadings, case law and motion practice to name a few. Other examples including the pre-identification of terms, key words, “hot topics” and proper names. In another embodiment, the system may take as an input a list of topics identified from other depositions (e.g., in the case of a topic extraction module). In an embodiment, the system is configured such that a user of the system may make accessible to the system this data in a variety of methods, including, inter alia, though bulk uploads to the system, drag and drop methods, and may identify for the system the nature of the data or documents made accessible to the system, such that the document type may be used as a factor in training the system.

### Testimony as a Training Input

The feature may separately utilize deposition testimony in a current case or past cases as a training input. In one embodiment, the training system utilizes content, such as transcription content from a past deposition or trial. Portions of that transcription, and in some embodiments, substantially all of the portions of one or more transcriptions of depositions or testimony (however parsed), may be utilized as input into an analysis engine or module. In an embodiment, and instead of or in addition to one or more segments of testimony being used as the input, other documents may be used as an input to searches of relevant or potentially relevant documents, with the collective results used as input into the system.

### Work Product as Training Input to DK Modules

The feature may separately utilize the content of attorney work product, emails between members of a case team, and memoranda. For example, the training data can include memos created by the litigation team that identify case themes or legal issues that they anticipate will be important in this case.

Utilizing Subsets of Documents and Data Within a Larger Subset of Documents (e.g., an eDiscovery Database) to Train the System.

The system can utilize information from prior cases to improve the predictive algorithms of the present system for use in a currently pending case. For example, the system can train a “Class Specific” Training Module, such as a Patent Litigation training module, using a training set of data from past intellectual property litigation matters. In the context of an IP case, the system can be supplied with a plurality of documents, and information relevant to sub-sets of that data can inform the system, such that the system becomes trained in reference to documents that have proven useful in prior IP cases. Such documents and their companion algorithms will have different predictive characteristics than those other “Class Specific” modules that have learned using data sourced from other classes of cases, such as mass tort cases, securities litigation, contract litigation, and the like.

In one embodiment, the system can be trained with multiple layers of knowledge. For example, the system can be trained using (a) the legal terminology pertaining to litigation in general (e.g., witness, deposition, trial exhibit, etc.); (b) the specific area of law, namely patent litigation, in this example; and (c) the case area domain, namely medical devices in this example. The system can use a subset of the case documents and associated metadata as the training set. Alternatively, and/or in conjunction, the system can also use the names of the people involved (e.g., potential witnesses) by party as the training set. Another training set can be a list of issues identified in the case assessment stage of the litigation. If the attorney is handling three different medical device patent litigation cases, each case will have its own set of parties, people, issues, and facts, but the underlying medical device knowledge will be common to all three cases, as will be the patent law knowledge, and the general litigation knowledge.

Outputs from the Analysis Modules/Engines

Regardless of the testimony and data analysis modules and engines used (e.g. topic extraction, sentiment analysis, objection analysis, question length, answer length, etc), once the modules have performed their operations on the testimony or testimony data that has been provided to them, the resulting data and analysis, as well as the testimony to which that data and analysis relates, can be utilized, searched, tagged, visually displayed, and linked to the page and/or line numbers in the original transcript to which they correspond.

In an embodiment, such as in the instance of data being submitted to a topic extraction engine, such as those available through Rev, displayed above, or Symbl.ai or any other topic extraction engine, additional steps can be taken to determine whether or not data serially sent to the engine has been received by the engine and processed by the engine successfully. The status of the processing may be reported back to a user in an embodiment, said reporting indicating what data has been processed successfully and what data has failed to be processed successfully, and what data is still in a queue to be processed.

Below is exemplar code for accomplishing this, wherein the data is being send to Rev via an API. In an embodiment, the system will determine if the various jobs are completed, utilizing job IDs or any other method for identifying the batches of data sent to the engine.

In an embodiment, the testimony analysis modules and engines may be internal engines or, in other embodiments, may be external engines accessed via an API or other networked means.

```
# Gets List of Topic Extraction Jobs from Rev
# User specifies name for the ExtractionJobs file and a number of jobs to include in this file
import requests
import json
import logging
import datetime
# Ask user for project folder path:
basepath = input(“Enter the PROJECT folder path: ”)
# Ask user for filename of output json file listing the jobs processed:
filename = input(“Enter ExtractionJobs filename to be stored (path will be RevOutputs/Jobs): ”)
jobs_file = basepath + “/RevOutputs/Jobs/” + filename
# Create logger
logging.basicConfig(filename = basepath + “/Extras/Issues.log”, level = logging. DEBUG)
logger = logging.getLogger( )
# Log time of this run
today = datetime.datetime.now( )
logger.info(f“\nGibson Log for {today}; RevJobs.py”)
log_format = “%(asctime)s::%(levelname)s:%(name)s:”\
    “%(filename)s::%(lineno)d:%(message)s”
logging.basicConfig(level=‘DEBUG’, format=log_format)
# Ask for user input of number of files to retrieve and pass that into the “limit” in the query
no_of_files = input(f“How many files do you want to retrieve? ”)
RevTkn = str(
  “02i8z1pUJcHNQ21ubEZQlHJ3tTvnPTtTUdbXV_spjIlAk3zX4ToNGPMEvVnsBwbs4aA_-
dSjCeChRRNKXSH6EGm-lN8lw”)
url = “https://api.rev.ai/topic_extraction/v1/jobs”
query = {
  “limit”: no_of_files, # Number of jobs to retrieve (default: 100, max: 1000);
  # TODO later pass this in from main.py
  # jobID, not date; also it will return jobs BEFORE (in time) not after this jobID
  “starting_after”: “” # s/b last job ID from the previous call
}
headers = {
  “Content-Type”: “application/json”,
  “Authorization”: “Bearer ”+RevTkn
}
response = requests.get(url, headers=headers, params=query)
data = response.json( )
# Add “jobs:” wrapper to make this a dictionary
data_jobs = {“jobs”: data}
# Dump the results into a json file with the name of ExtractionJobs_ProjectName.json (specified by
user)
with open(jobs_file, ‘w’) as f:
  json.dump(data_jobs, f, indent=2)
logger.info(f“{filename} is ready in RevOutputs/Jobs”)
print(f“{filename} is ready in RevOutputs/Jobs”)
```

In an embodiment, once the testimony data has been analyzed by a testimony analysis module or engine, the data or analysis resulting from that is retrieved or received. Below is exemplar code taking the output of the topic extraction and retrieving it. In an embodiment, retrieved information will include the portions of testimony, the length and offset information or other information that may be utilized to organize the output.

```
  # For each completed job in an ExtractionJobs json file, retrieves job from Rev
  # User specifies the ExtractionJobs filename (must be in RevOutputs folder)
  import requests
  import os
  import json
  import shutil
  import logging
  import datetime
  # Ask user for project folder path
  # add “RevOutputs” as folder where data will be stored
  project_path = input(“Enter the PROJECT folder path: ”)
  output_path = project_path + “/RevOutputs/”
  failed_path = project_path + “/RevInputs/” # Jobs go back to RevInputs to be re-
  submitted again
  processing_path = project_path + “/RevInputs/Processing/”
  # Create logger
  logging.basicConfig(filename = project_path + “/Extras/Issues.log”, level =
  logging.DEBUG)
  logger = logging.getLogger( )
  # Log time of this run
  today = datetime.datetime.now( )
  logger.info(f“\nGibson Log for { today }; retrieveJobs.py”)
  log_format = “%(asctime)s::%(levelname)s::%(name)s::”\
        “%(filename)s::%(lineno)d::%(message)s”
  logging.basicConfig(level=‘DEBUG’, format=log_format)
  # Initialize variables
  counter = 0
  saved_count = 0
  RevTkn = str(
  “02i8z1pUJcHNQ21ubEZQlHJ3tTvnPTtTUdbXV_spjIlAk3zX4ToNGPMEvVnsBwbs4a
  A_-dSjCeChRRNKXSH6EGm-lN8lw”)
  def revResults(id):
    # Rev code for getting results of Topic Extraction
    url= “https://api.rev.ai/topic_extraction/v1/jobs/” + id + “/result”
    query = {
      “threshold”: “0.1”
    }
    headers = {“Authorization”: “Bearer ”+RevTkn}
    response = requests.get(url, headers=headers, params=query)
    topic_data = response.json( )
    return (topic_data)
  # TODO when converting to a funcion, this file is the “filename” from the RevJobs.py
  file
  file = open(output_path + “Jobs/” +
        input(f“Enter filename for ExtractionJobs_file.json:\n ”), “r”)
  jobs_string = file.read( )
  data = json.loads(jobs_string)
  # Ask for Batch prefix so we can strip it from the metadata in case we need the filename
  batch_prefix = input(f“What is the batch prefix appended to the filename? ”)
  # NOTE if there are jobs in the ExtractionJobs_x.json file that have a different
  “batch_prefix”
  # then the one specified here, the code will throw an error when splitting the metadata
  text
  # TODO add error handling for this later; for now just delete the extraneous data from the
  json file
  for job in data[‘jobs']:
    # check to make sure the job has completed
    if job[‘status'] == “completed”:
      job_id = job[‘id’]
      data = revResults(job_id)
      with open(output_path + job_id + “.json”, ‘w’) as f:
        json.dump(data, f, indent=2)
      logger.info(f“{job_id}.json saved”)
      saved_count += 1
    elif job[‘status'] == “failed”:
      # move text file to Failed folder for re-submission
      # eventually add a function in this file and call it
      metadata = job[‘metadata’]
      file 2move = metadata.split(batch_prefix)[1]
      logger.info(f“File to move is: {file_2move}”) # sanity check
      # Find the file in folder /RevInputs/Processing
      for entry in os.listdir(processing_path):
        if os.path.isfile(os.path.join(processing_path, entry)):
          if “.DS_Stor” in str(entry):
            continue
          else:
            if file_2move == entry:
              # Move the file to Failed folder
              shutil.move(processing_path + file_2move, failed_path + file_2move)
              counter += 1
    else:
      continue
  logger.info(f“Done: Saved {saved_count} completed files; Moved {counter} failed jobs
  for resubmission”)
      print(f“Done: Saved {saved_count} completed files; Moved {counter} failed jobs for
      resubmission”)
file.close( )
```

In some embodiments, an additional step may be taken to map data relative to a larger set of data of which it is a part. For example, analysis done on a section of text originally sourced from a deposition or trial transcript may be linked or mapped to a specific page number where the underlying testimony was originally found in a certified transcript, for example.

In an example of a deposition where a witness is speaking on 100 different topics, one of which relates to the chemical phenylethylamine, a topic extraction engine may identify where the witness spoke about phenylethylamine, for example on page 76, 79 and 130. In embodiments where the topic extraction engine was not provided with page numbers but rather was provided with question and answer pairs or just portions of the text, an additional step may be taken to identify where the topic extracted from that text would be located in the original transcript, so that later it may be mapped into a visual depiction of the data.

Below is an example of one method used to in conjunction with an exemplar embodiment.

```
from lib.readLines import Document
from lib.readLines import Page
import json
import logging
import datetime
import os
# Loops through RevInputs text files and corresponding topic extraction json files
# This will map the offsets in json and add corresponding page numbers from text file
basepath = input(“What is the PROJECT folder path?”)
extr_jobs = input(“Enter the ExtractionJobs filename: ”)
extraction_jobs = basepath + “/RevOutputs/Jobs/” + extr_jobs
# Ask for Batch prefix so we can strip it from the metadata when we need the filename
# Assume batch prefix is of the format “Project_b1_” so we use parts 2 AND 3 together as the
filename
# Create logger
logging.basicConfig(filename = basepath + “/Extras/Issues.log”, level = logging.DEBUG)
logger = logging.getLogger( )
# Log time of this run
today = datetime.datetime.now( )
logger.info(f“\n\nGibson Log for {today}; map_pgs.py; {extr_jobs}”)
log_format = “%(asctime)s::%(levelname)s::%(name)s::”\
      “%(filename)s::%(lineno)d:%(message)s”
logging.basicConfig(level=‘DEBUG’, format=log_format)
# Determine page number format in text file, options below (FOR LATER) -----> TODO: UPDATE with
newer expressions Jan 26, 2023
regex1 = r“\hat{ }Page (\d+)” # right (or left?) justified “Page nnn” format
regex2 = r“\hat{ }\s{3,}(\d+)$” # right justified digits only
regex3 = r“\hat{ }(\d+)$” # left justified digits only
# TODO eventually get the format from elsewhere, then pass that into Document( )
counter = 0
# Loop through files based on ExtractionJobs_yyyymmdd.json
with open(extraction_jobs, “r”) as jobs_file:
  jobs_string = jobs_file.read( )
  data = json.loads(jobs_string)
  # For each job id corresponding to a text file chunk, add corresponding page numbers
  # and save in a new json file
  for job in data[‘jobs']:
    job_id = job[‘id’]
    metadata = job[‘metadata’]
    depo_file = metadata.split(‘_’)[2] + ‘_’+ metadata.split(‘_’)[3] ## removed batch prefix
    json_file = job_id + ‘.json’
    # Skip over jobs that have failed or are still processing
    if job[‘status'] == “failed”:
      continue
    elif job[‘status'] != “completed”:
      continue
    else:
      pass
    # Working files for this run (MANUAL INPUT for now)
    filetxt = basepath + “/RevInputs/Processing/” + depo_file
    # Depo file chunk
    filejson = basepath + “/RevOutputs/” + json_file
    # topics output file
    #filejson = basepath + “/RevOutputs/LeftJustified/” + json_file # topics output file
    new_json_file = basepath + “/Outputs/” + job_id + “_pages.json” # new output w page nos
    try:
      test = Document(filetxt)
    except FileNotFoundError as err:
      logger.error(f“{err} >> No {depo_file} found, mapping skipped for job_id: {job_id}”)
    else:
      # ------------------ Now loop through topic json file items -------------------------
      # load topic output json file and loop through offsets
      try:
        with open(filejson, “r”, encoding=‘ISO-8859-1’) as file:
          pass
      except FileNotFoundError as err:
        # TODO Better still: get missing file from Rev and try again
        logger.error(f“{err} >> No jobid.json file found, so no pages mapped ({depo_file},
{json_file})”)
        continue
      else:
        counter = 0
        with open(filejson, “r”, encoding=‘ISO-8859-1’) as file:
          json_str = file.read( )
          jdata = json.loads(json_str) # dictionary
          topics = jdata[‘topics'] # list of topics
          # loop through the topics in the jobid.json file
          for entry in topics:
            this_topic = entry[‘topic_name’]
            info = entry[‘informants']
            #OLD print(f“-------------- topic: ‘{this_topic}’ --------------------”)
            # loop through informants
            for item in info:
              offset = item[‘offset’]
              item[‘page’] = 0 # adds ‘page’ placeholder for each item
              # get page no from Document class
              try
                page_no = test.get_page_no(offset)
              # adding error handling for an infrequent TypeError (‘NoneType’ when expecting a
‘string’) that pops up
              # this also shows up when the Regex doesn't match the document's formatting
              except TypeError as err:
                logger.error(f“{err} >> Page no issue {metadata}, {json_file}”)
                #continue ## when I add the Regex switch or all formats are the same
                counter += 1
                break
              else:
                #OLD print(f“Position is: {offset}, page: {page_no}”) # sanity check
                item[‘page’] = page_no
        # ---------------------- add page no to new json file ------------------------
        with open(new_json_file, “w”) as f:
          json.dump(jdata, f, indent=2)
          print(f“Page update done; {depo_file}, {job_id}”)
          logger.info(f“Page update done; {depo_file}, {job_id}”)
      finally:
        pass
    finally:
  pass
```

In the above exemplary code, page numbers (content characteristic) are mapped to the topics extracted by the topic extraction engine. The above is merely an example of code that can be utilized. A similar mapping algorithm can be used for mapping a witness name (a participant characteristic) to parsed sections of the transcript data, such as question and answer pairs.

In embodiments, the testimony data and associated data examined above including data generated with testimony analysis modules or engines, may be exported and stored in any one of a number of methods as known in the art, including in databases. Some exemplars of these methods are discussed herein.

The data generated from the analysis and extraction of data from those transcripts and generated from testimony data may then be organized and stored (e.g., using tables in databases) then using various tools depicted visually, searched, parsed, annotated, compared, and examined and exported in a variety of different methods which are explained herein.

In an embodiment, testimony data and data and the results of analysis of that data may be displayed via data visualization tools, such as: Tableau, QlikView, Power BI, Looker, TIBCO Spotfire, SAP Lumira, IBM Cognos Analytics, Microsoft Excel (with Power View and Power Pivot), Google Data Studio, Highcharts. It may also be interacted with, layered and/or viewed through various lenses. Reports, depicting desired subsets of the data, may be exported into new files and shared.

The above is an example of one process that may be utilized to obtain transcripts, data, clean that data, analyze that data, and store the analysis and segments of that data in a manner that can be visually depicted. These are exemplar systems and methods. Some of these steps are elaborated on and alternative systems and methods are discussed herein.

### Files Containing Speech by Multiple Speakers are Aggregated and Diarized.

In an embodiment, and as a first step, one obtains one or more documents or files containing a record of discourse between two or more parties.

In an embodiment, the files contain information comprising or related to communication between two parties (e.g., a conversation, an interview, colloquy, a press conference, debate, legal proceeding or deposition, lecture or Socratic dialogue, round table discussion, among others).

The files may but need not be of a uniform file type or formats within a file type. In an embodiment, files may be comprised of both paper documents and/or electronic file types (e.g., computer files).

### Physical Documents

In an embodiment, the physical files may comprise paper documents, such as transcripts or records or other printed records.

In an embodiment, the paper documents are scanned, analyzed and/or converted or otherwise transformed into electronic records. In an embodiment, the electronic files so created are converted into one or more formats that recognize text and alphanumeric content, if not already in such a format.

### Electronic File Type and Format

The files may be in any format suitable for storing a record of communication between multiple individuals, whether that record is an audio record (e.g., digital auto recording), audiovisual (e.g., videotape record of multiple individuals communicating), or transcribed (e.g., a written record of individuals communicating as captured by a transcriptionist or via technology, such as speech-to-text technology). Example file types capturing one or more of these methods include: PDF, PTX, Visionary, ASCII, TXT, MPEG1, MPEG2, AVI, LEF, FLVs, or CMS, for example.

Examples of audio file types that compatible with one or more embodiments include: M4A, FLAC, MP3, MP4, WAV, WMA, AAC. Exemplar text or caption file types compatible with one or more embodiments include: TXT, RTF, JSON, SubRip (*.srt), WebVTT (*.vtt), among others. Other file types may be employed without departing from the scope of the invention. The data may be structured or unstructured.

Converting Electronic Content (Audio or Audio/Visual) into Text (Diarization)

In an embodiment, file types containing audio or audiovisual discourse content, wherein the content contains a records of speech in, for example, audio form (e.g., audio recordings, video or digital video recording) containing all or a portion of the file content is converted (or analyzed and extracted or similar) into text and/or alphanumeric content. In an embodiment, this may be accomplished through the use of a speech to text module.

Any other means of converting audio or audiovisual or other similar electronic content into a textual and/or alphanumeric format may be utilized without departing from the scope of the invention.

In an embodiment, extracted audio content is additionally differentiated and/or diarized using any method known in the art, such that the speech of one participant or speaker is differentiated from the speech of a second, third and fourth speaker (and so on).

In an embodiment, the diarized transcription of one or more records is rendered or formatted into one or more substantially similar formats, which contain records of speech and in some embodiments, other information. In an embodiment, one substantially similar format will contain a record of speech attributable to individuals (whether specifically named—e.g., Mr. Smith, Ms. Jones—or non-specifically identified (e.g., Speaker One; Speaker two; Speaker three) or identified by role (any role, e.g., the witness).

In an embodiment, time-related information is associated with dialogue content. In an embodiment, the timing of the speech of one participant in a dialogue or communication is differentiated from the timing of the speech of the same individual (if it occurs later or earlier) or differentiated from the speech of other individuals (whether earlier, later, or contemporaneous thereto).

### Additional File Content—Information not Comprising Dialogue

In an embodiment, one or more of the files may also contain additional information not comprising communication or dialogue content, as well as references to additional information not wholly contained in the file. Information may be of any type or relevant to any matter.

In an embodiment, the files may contain information that relative to the context (in the broad sense) in which the communication or dialogue (for example) between parties takes place. Such as: the location of the conversation (e.g., address, etc.,); the participants' and/or any non-participant party's identities, qualifications, roles, affiliations, etc.; information regarding any official or legal proceeding related to the communication (e.g., in the case of a litigation matter); date and time information, information related to the duration of the communication recorded or the timing and breaks taken, as well as any other information which may be stored on or referenced in the file.

Additionally, an example of information references in the file may include references to other information or documents, the substance of which is stored outside of the files themselves. In an embodiment, the files may include links (e.g., hyperlinks) or references sufficient to (or helpful for) locating and accessing the additional information or documents stored outside of the files.

All or a portion of such additional, non-dialogue content, may be identified and/or extracted and utilized in conjunction with the invention without departing from the scope of the invention.

Categories of similar or identical information may occur across file types, such that identical types or fields of information may be identified, tagged, extracted, analyzed, and/or compared across otherwise disparate records and files. Representations of data sourced from multiple records may be represented in one or more manners, such as via the visual depiction of data. The files themselves may be categorized for reference.

Converting the Records into Uniform Formats

In an embodiment, files and or extracted information or data from one or more files may be converted into one or more uniform or substantially uniform formats, for example by utilizing a batch converter module to convert multiple files at once wherein one selects or designates the files of different types to convert, then identify the chosen target format. An advantage of this is to facilitate the identification and extraction of certain classes of data across records through any means.

### Common Field Identification

In an embodiment, the files may also contain one or more substantially similar fields containing content. In an embodiment, the content in those fields can be communication content (including in an embodiment question and answer pairs or question and objection pairs).

Below is an example of code in Python which can assist in this process, in one embodiment:

```
import re
  def extract_qa pairs(text):
  qa_pairs = [
  lines = text.split(“\n”)
  for i, line in enumerate(lines):
  if line.endswith(“?”):
  question = line
  answer = lines[i+1] ifi+1 < len(lines) else None
  qa_pairs.append((question, answer))
  return qa_pairs
  text = “What is your name?\nJohn\nWhat is your age?\n30\nWhat
  is your phone number?\n555-555-5555”
  qa_pairs = extract_qa_pairs(text)
  for q, a in qa_pairs:
  print(“Question:”, q)
  print(“Answer:”, a)
  print(“---”)
```

In this example, the function extract_qa_pairs takes a string text as input and returns a list of question-answer pairs. The function splits the input text into lines using the split method, and then uses a loop to iterate over each line. If a line ends with a question mark (?), the line is considered to be a question and the next line is considered to be its answer. The question and answer are then added to a list qa_pairs as a tuple. Finally, the qa_pairs list is returned.

In this example, the input text is a string with several question-answer pairs separated by newline characters. When the script is run, the extract_qa_pairs function returns a list of tuples with the extracted question-answer pairs, which are then printed to the console.

Note that this is just a simple example. One may modify the logic of the extract_qa_pairs function as appropriate for the specific requirements or format of the text. More advanced techniques such as natural language processing may be employed to accurately identify question-answer pairs in more complex text documents.

In an embodiment, the content of those fields may contain any other non-dialogue content, information or values. In an embodiment, information from one or more fields may be identified, searched, extracted and/or analyzed using AI or machine learning means or via a user.

In an embodiment, an identification module may be utilized to identify fields of data within, for example, text documents, such as addresses, phone numbers, email addresses, and more, so that they can be converted into structured data. By way of example, below is an example of one way in which this can be accomplished:

```
import re
def extract_data(text, fields):
  data = { }
  for field in fields:
    match = re.search(field + “: (.*)”, text)
    if match:
      data[field] = match.group(1)
  return data
text = “Name: John Doe\nAge: 30\nPhone: 555-555-5555\nEmail: john.doe@example.com”
fields = [“Name”, “Age”, “Phone”, “Email”]
data = extract_data(text, fields)
print(data)
```

This exemplar code uses regular expressions (Regex/re) to search for specified fields of data within the input text. The extract_data function takes two arguments: the input text and a list of fields to extract. The function uses a loop to search for each field in the text, and if a match is found, the field and its value are added to a dictionary data. Finally, the function returns the data dictionary. This is one approach. Others may be employed to search for and identify specific fields of data.

Any means of identifying and extracting or tagging (or similar) fields of data across records may be utilized without departing from the scope of the invention.

### Document/Record/Extracted Content Storage

In an embodiment, all or a portion of the converted physical files and/or the electronic files and or extracted information or content are stored by electronic means. Content can be in structured or unstructured form. In an embodiment, all or a portion of the files are stored in a cloud-based system. In an embodiment, all or a portion of the files and/or extracted content are stored electronically in a non-cloud based environment. In an embodiment, original files may be stored separately from files produced from those original files. In an embodiment, content extracted from those files may be extracted and stored separately from the original or converted files.

### Operations on Content and Extracted Content—Topic, Conceptual and Semantic Content Identification, Extraction, Quantification.

Some aspects of this have already been addressed. In the context of one or more files containing a textual representation of communication between one or more parties, the system and method may utilize topic identification and extraction tools to identify and/or extract and represent topics raised or discussed by one or more of the parties during the course of the communication session.

The reference to topic extraction here is meant as an examplar. Other testimony analysis engines and modules may be utilized such as modules employed to perform sentiment analysis, or identify and analyze objections, determine the length of witness answers or attorney questions. Numerous other examples of analysis modules are set forth herein.

Taking for the moment the example of a topic extraction module, several methods may be employed in various embodiments. By way of example and not limitation, Latent Dirichlet Allocation (LDA), a topic modeling algorithm, may be employed to identify topics within text by assuming that each document is a mixture of topics, and that each word in a document is generated by a topic. LDA can be implemented using Python libraries such as gensim and scikit-learn.

Another option in an embodiment is to utilize Non-negative Matrix Factorization (NMF), which is a topic modeling algorithm that can identify topics within text by factorizing a document-term matrix into two matrices: a document-topic matrix and a topic-term matrix. NMF can be implemented using Python libraries such as scikit-learn.

TextRank may be utilized in an embodiment. TextRank is a graph-based algorithm that can identify topics within text by treating each document as a graph, where words are vertices and edges represent relationships between words. TextRank can be implemented using Python libraries such as networkx and nltk.

Additionally, in one embodiment, the Term Frequency-Inverse Document Frequency (TF-IDF) may be utilized as a method that can identify important words within a document by considering both the frequency of a word within a document (term frequency) and the number of documents in which the word appears (inverse document frequency). TF-IDF can be implemented using Python libraries such as scikit-learn.

As one will appreciate, these are just a few examples of tools that can be used for identifying topics within text. The best tool for a given task will depend on the specific requirements of the task and the nature of the text data.

In an embodiment, the system may utilize other tools to identify and/or extract and represent semantic or conceptual or similar content contained in one or more files.

### Topic Identification and Extraction

In an embodiment, the system may be configured to quantify the presence of similar topic (or conceptual or semantic or similar) content (across one or multiple records) in any of variety of ways. In an embodiment, the system and method may quantify content by time spent (or estimated to have been spent) discussing that content (in minutes or as a percentage of the communication or identified set of communications as a whole). In another embodiment, the system and method may quantify content by estimating the number of words expended by one or more participants in a communication. Any means of quantifying may be employed without departing from the scope of the invention. Below are exemplar visual depictions of concept or topics extracted and quantified by a concept module.

Depo Concept Extraction

| Concepts Name | Score | Quartile 1 | Quartile 2 | Quartile 3 | Quartile 4 |
|---|---|---|---|---|---|
| mchavern paper | 0.84 | | 0.84 | | |
| rambus 2000 | 0.57 | 0.39 | 0.97 | 0.35 | |
| Elsevier | 0.52 | | | 0.52 | |
| load capacity | 0.40 | | | | 0.40 |
| clinical trial | 0.39 | 0.39 | | | |
| nitrogen levels | 0.37 | | | | 0.37 |
| hybrid cloud | 0.36 | | 0.32 | | 0.40 |
| lowell study | 0.35 | | | 0.34 | 0.36 |
| dr. fessler | 0.34 | | | | 0.34 |
| pilot study | 0.34 | | | | 0.34 |
| semiconductors | 0.32 | | 0.32 | | |
| virtual machine | 0.32 | | | 0.32 | |
| richard singer | 0.31 | | 0.31 | | |

Below is an embodiment of the visual depiction of extracted topic data from a single deposition, wherein the size of the blocks depict the relevant number of times that a topic was discussed during the deposition.

Below is another exemplar of how topical data obtained from a topic extraction module may be depicted wherein each of the words below corresponds to a topic and the size of the words correspond to the volume of content in the greater deposition that was devoted to that topic.

In an embodiment, data depicting quantified topics, concept and/or semantic content may be appended to the transcript of a communication record, may be limited to content that rises to a certain defined threshold or thresholds. For example, concept or topic data may be excerpted for on the top 10 or 20 most prevalent topics, as measured by a desired method. Similarly, in an embodiment, the system and method may be utilized to ascertain the top topics (as identified by any chosen method) prevalent across multiple records or a specific class or type of records stored in a system. For example, topics may be extracted from records related to certain classes or categories of speakers.

Said information may be utilized to examine information for only a subset of documents, as in the case of legal matters (e.g., product liability matters below)

In an embodiment, the system and method may permit a user to identify, across a single document or a set of documents, any individual that has spoken about a specific topic or concept. In an embodiment, the system and method can be employed to allow an individual to select one or more topics and extract the identified communication content that was identified as being relevant to one or more specific topics.

By way of example, the system and method may contain a record of dialogue in the form of 100 political debates or 100 legal proceedings or 100 telephone records of recorded conversations (each involving one or more speakers) (as examples). The system and method utilizes topic extraction module (as an example) to identify the 20 most prevalent topics discussed in any of these sets of records, and for any one of those identified topics, the system may be employed to identify in which of the specific records (whether all of them or a subset of them) the topic was discussed, when and for what duration. The system may then be utilized to extract the specific speech in questions. In such a way, the system and method can be utilized to quickly find specific topics discussed across numerous records.

In an embodiment, the system and method can, utilizing diarized content such that speech components (e.g., words) are attributed to specific participants, identify the average length of a speech segment, whether in words or in time, as depicted below

The same method may be utilized to depict and analyze the length of an attorney's questions, or the objections thereto.

In an embodiment, extracted topic, witness and attorney data may be appended to a transcript of a record, such as a deposition, such that a reader can ascertain quickly the topics discussed as well as any metrics related to the deposition or participant behavior without having to read the deposition transcript.

### Visual Depiction of Testimony Data

Once the data is extracted, prepared, cleaned, stored and/or dealt with via the processes set forth herein, it may be displayed via data visualization tools, such as: Tableau, QlikView, Power BI, Looker, TIBCO Spotfire, SAP Lumira, IBM Cognos Analytics, Microsoft Excel (with Power View and Power Pivot), Google Data Studio, Highcharts, It may also be interacted with, layered and/or viewed through various lenses.

Reports, depicting desired subsets of the data, may be exported into new files and shared. Below, in one embodiment, is a visual depiction of data extracted and stored utilizing methods displayed herein, and visually displayed using Power BI. Other visualization tools may also be employed to represent the data extracted from depositions without departing from the scope of the invention.

Below are exemplars of how data from multiple depositions can be visually depicted and compared. These are examples of topic extraction data. Other types of data relating the underlying testimony (sentiment analysis, etc., objection analysis, etc.,) can be visually depicted as well.

Below is an example of extracted topics from multiple witnesses, wherein the extracted topics are mapped back to the page numbers within the depositions. One, two or more witnesses may be compared and the underlying testimony pulled and examined by the system. In an embodiment, question and answer pairs can be extracted and displayed from one or more witnesses. In an embodiment, citations to the locations (e.g., page, lines) in the underlying record may also be detected and depicted. In an embodiment, the system may store original legal proceeding transcripts, which may be accessed via links (see Filename, below).

In an embodiment, the system may be configured to “zoom out” and, in addition to the depicted question and answer pair (or, in an alternative embodiment not involving question and answer pairs, simply a desired subsection of the record) depict as well question and answer pairs that precede or follow the Q & A content (or additional content occurring prior to or following the excerpted content in situations in which Q & A pairs are not utilized).

In an embodiment, the system may be configured to enable multiple users to access the data and, if desired, flag or tag portions of the testimony. For example, the system may be configured to permit one or more users to designate portions of the data as being of particular interest or relevant to different aspects of a legal matter (damages, liability, etc.), and, in some embodiments, may append or associate with segments of that testimony written notes which may be reviewed by other users of the system.

In an embodiment, topic extraction data may be visually mapped relative to the page numbers of the underlying transcript. For example, in the embodiment shown below, different extracted topics are assigned a color, and the presence of that topic within the transcript is depicted relevant to the page numbers. Other types of data may be similarly disclosed, such as the presence of objections and the presence of sentiment.

Note below that the interface may depict any type of data, whether from a single transcript or from multiple transcripts. The instance below, aggregate data from five depositions are depicted, with 69 separate topics identified and visualized in a manner that conveys the quantity of testimony associated with each topic.

Below is another example of topic data mapped across transcript pages. In an embodiment, the system may be configured to enable a user to click on any one of these data points and extract the testimony itself.

As will be apparent from the mapped topics, one may be able to identify quickly instances in which two or more topics are discussed in proximity with each other because both fall on the same page number.

In an embodiment, the system may be configured to selectively examine data of particular interest, as depicted below in an embodiment.

In an embodiment, the topic extraction engine (or other engines) may be configured to display topics that have been identified based on a confidence level (or similar). For example, the user may wish to visually depict only extracted topics that have been identified based on a high confidence score (image directly below).

Alternatively, the user interface can depict topics that have been extracted based on a lower confidence scores, effectively yielding more topics, as depicted in the images below. Note in an embodiment, the user may toggle the values associated with the data as desired.

Similarly, the data may be depicted in any compatible fashion, including word clouds, as depicted below, visual depictions based on user-designated value criteria.

As will be appreciated by one in the art, the many classes of data identified and extracted from transcripts may be depicted in a wide variety of ways, and the user may interact with that data in a variety of ways. Below is a depiction of topics addressed by five different witnesses, wherein a user may highlight one of the witnesses and the topics discussed can be depicted. In an embodiment the user may drill down on the topics for each witness to see additional data, including extracted testimony corresponding to that topic.

In another embodiment, a user may utilize the interface to identify topics alphabetically, may then designate one or more topics, and depict the corresponding testimony, depict the witnesses, and display various objective metrics, such as topic counts (the total number of topics) and the testimony count based on the topics selected. Many variations for depicting data found in transcripts are possible without departing from the scope of the invention.

Additionally, the system may be equipped with a help screen to assist the user in utilizing and navigating the system, as depicted below.

### Measurement of Other Speech or Behavioral Metrics

The system and method may be utilized to obtain a wealth of information related to the behaviors of attorneys and witnesses during any one deposition or any set of depositions, by extracting and measuring everything that occurs. By way of example, the system and method may be employed to extract the topics addressed and quantify the amount of time spent discussing them; extract and analyze the questions asked, the answers provided, the objections made and not made, documents used and re-used and not used at all (and the types of witnesses they're put in front of); it may be utilized to measure the lengths of questions and answers in words or time, including who speaks fast and who speaks slowly and when during the course of the deposition; by analyzing instances in which a transcript reflects two people speaking at once, the system and method can quantify the propensity of an attorney to talk over another attorney or over a witness (and if their behavior differs if the other attorney/witness is a man or a woman or younger or older or how long they've been practicing).

The system and method may also be used to identify and measure whether attorneys strategically talk over a witness to garble the testimony they don't like (trying to deprive them of a clean quote to use in motion practice or at trial), as well as the frequency of breaks and their duration and who calls them and why. As stated, the system and method are powerful because they can analyze aggregate data revealing the habits of the people over time and across disparate matters. By incorporating technologies that detect and gauge the emotional state of parties (witnesses and attorneys) over the arc of a deposition, and map the presence or absence of emotional states over other data, such as topics discussed, documents used, etc., such that one may detect patterns of emotional states relative to other measured factors. The system and method may further incorporate, in the context of litigation, resolutions, such that resolution amounts or jury decisions (if denominated monetarily), such that the system and method may correlate the presence of people (attorneys, witnesses) and their roles to specific outcomes: again trial results (occasionally) but also settlement outcomes.

Shown in Fig below is a sample deposition scorecard for an expert deposition in an IPR proceeding. In addition to the data shown (exemplar data), corresponding aggregate or average data can be provided for comparison on any of the metrics depicted. For example, we can show the overall average for all transcripts analyzed (either for a single project, or the whole universe of transcripts). We can also show average or mean metrics by witness type, case type, jurisdiction, etc. Those averages will give the users more context for comparison of the particular deposition in question.

In addition to the above, the system and method may be utilized to generate a narrative summary of part or all of a deposition, or of multiple depositions. In an embodiment, the system and method employ a summarization module, which may take as an input extracted testimony data and then using one or more tools to provide a narrative summary that is shorter than the data it summarizes. In one embodiment, the user may be provided with input options that inform the summarization module of the desired length of the summary or, in an alternative, an amount of compression.

In an embodiment, the summarization module may employ: AI-powered text summarization tools that can analyze a large amount of text and generate a concise summary (examples of which include Gensim, Summarizer, and OpenText Extract); Automated summarization software and tools which utilize natural language processing and machine learning algorithms to condense the text into a shorter version (examples of which include Autosummarizer, AYLIEN Text Analysis, and Lexalytics); online summarization tools, i.e., web-based tools that allow the system to link to and submit text to an online interface and generate a summarized version (e.g., Small SEOTools, Online-Summarizer, and SummarizeThis); and text compression algorithms, including mathematical algorithms that can condense text by removing redundant or irrelevant information (e.g., the PJS algorithm, the FGSM algorithm, and the LZW algorithm). Other methods may be employed without departing from the scope of the invention. In an embodiment, a user may designate which tools (of multiple available tools) utilized by or integrated with the module will be used to generate or regenerate the summary.

Because automatic summarization tools may not always produce accurate or coherent summaries, and given the importance of accuracy in the field of law, in an embodiment, the summarization of testimony generated by the module may bear a mark or other designation noting that it has been generated via a text summarization module and employed tools and that the summary has not yet been reviewed or corrected or verified by an attorney. In such a manner, other members of a litigation team may be informed that they should not assume that the summary is complete or an accurate summary unless and until it is approved by a human. In an embodiment, the system and method provides a user interface which permits a user to review and remove the cautionary designation after it has been altered or approved. In an embodiment, the system will identify and store the record of which individual has approved the summary.

Despite these accuracy limitations, however, narrative summaries may be utilized by attorneys or participants or others as a “starting place” for the creation of memos which may be completed, corrected and elaborated on by a human, in many cases by a human that was present during the testimony or, less optimally, by someone who has later read the testimony rather than an algorithmically synopsized version of it.

In addition, a partial list of things that may be measured and quantified using the system and method techniques disclosed herein. These are examples of content characteristics and participant characteristics that can be assigned to parsed elements of testimonial data.

### Operations on Content and Extracted Content—Information not Comprising Dialogue

As indicated, records may contain dialogue content and non-dialogue content. The system and method may identify, tag, extract, store and analyze such content utilizing various operations and modules.

By way of example, and not of limitation, in the context of a record of a legal proceeding, the following exemplar fields of information may be identified (via any means), tagged, extracted, and analyzed and depicted (see below exemplar fields). In some instances, information may not explicitly be found within the document but may be derived from or estimated from the contents of the document. For example, the record of the legal proceeding may contain a definitive start time, break times, and end times, but may not explicitly state the duration of the proceeding. Nevertheless, the system may be configured to derive the actual duration based on the existing information.

Examples of non-testimony data in the exemplar context of a legal proceeding, such as a deposition, may include, by way of example, the case type, the individuals present (attorneys, witnesses, court reporters) including their roles (taking or defending attorney; witnesses; etc), affiliations (the firms, corporations, or entities with which they are employed or aligned with), and their dispositions (neutral, aligned or adverse to a particular party). Additional categories of non-testimony data may be utilized without departing from the scope of the invention
1. Information about the case or legal proceeding
   a. Type of case
      i. Antitrust
      ii. Bankruptcy
      iii. Civil Rights
      iv. Consumer Protection
      v. Contracts
      vi. Copyright
      vii. ERISA
      viii. Employment
      ix. Environmental
      x. False Claims
      xi. Insurance
      xii. Patent
      xiii. Product Liability
      xiv. Securities
      xv. Tax
      xvi. Torts
      xvii. Trade Secret
      xviii. Trademark
      xix. Remaining Federal
   b. Case identification
      i. Name
      ii. number
   c. Parties
      i. Plaintiffs
         1. Individual or corporation or other
         a. Firms representing them
         i. Primary firm
         1. Representing attorneys
         a. Role at firm
         i. Partner
         ii. Associate
         iii. Of Counsel
         iv. Other
         2. Local counsel
         a. Role at firm
         i. Partner
         ii. Associate
         iii. Of Counsel
         iv. Other
      ii. Defendants
         1. Individual or corporation or other
         a. Firms representing them
         i. Primary firm
         1. Representing attorneys
         a. Role at firm
         i. Partner
         ii. Associate
         iii. Of Counsel
         iv. Other
         2. Local counsel
         b. Role at firm
         i. Partner
         ii. Associate
         iii. Of Counsel
         iv. Other
         iii. Third parties
         1. Individual or corporation or other
         a. Firms representing them
         i. Primary firm
         1. Representing attorneys
         a. Role at firm
         i. Partner
         ii. Associate
         iii. Of Counsel
         iv. Other
         2. Local counsel
         c. Role at firm
         i. Partner
         ii. Associate
         iii. Of Counsel
         iv. Other
   d. Court
      i. Federal
         1. Specific State
      ii. State
         1. Specific State
   e. Judge
      i. Specific Judge
2. Questioning attorney
   a. Identify of other attorneys attending from that firm
      i. Remotely
      ii. In-person
   b. Questioning attorney behavior
   c. Question data
      i. Length
      ii. Content
      iii. other
3. Defending attorney
   a. Identify of other attorneys attending from that firm
      i. Remotely
      ii. In-person
   b. Objection data
      i. Type
      ii. Content
      iii. other
4. Witness
   a. Name
   b. Role
   c. Witness type (fact, 30(b)(6), expert, etc.)
   d. Witness information
   e. Length of answers in words
5. Objections made during the course of the deposition
   a. Objection type
6. Location of deposition
   a. Address, suite, room, state, country, etc.
7. Date of deposition
8. Time
   a. Start time
   b. End time
   c. Break times
   d. Off the record times
   e. Other
9. Duration
   a. Words by every participant
      i. Kind
      ii. number
10. Ending time of deposition
11. Number of breaks—requested by attorney
   a. Length of break when requested by attorney
12. Number of breaks—requested by witness
   a. Length of break when requested by witness
13. Length in deposition in minutes
14. Number of exhibits
15. Types of exhibits
   a. Electronic Documents
16. Identity of exhibits
17. Order in which exhibits are used
18. Time spent with each exhibit
19. Use of those exhibits (or versions of them) in other testimony
20. Identify questions asked about those exhibits
21. Identify answers given regarding questions posed about those exhibits

The above are exemplars of non-testimony related data that can be identified within the deposition. In addition, codes provided by the SALI (Standards Advancement for the Legal Industry) Alliance can be used.

By identifying classes of dialogue content and non-dialogue content, the system can extract and represent data from across any number of files to provide insights into what occurred, as well as data related to specific individuals (debate participants in the context of debates) or witness or attorney statistics across one or multiple records. The system and method may then analyze some or a part of the data drawing on data derived from both dialogue data and non-dialogue data, and may represent that data in any way desired. For example, one may readily identify the frequency of objections made to questions posed by a specific attorney, across multiple litigation cases, and provide those statistic across various witness types (depicted below), thereby providing insights in advance of a future deposition how that same attorney may behave with a future witness.

Similarly, the same methods may be employed to identify the types of documents a questioning attorney uses with specific classes of witnesses. Knowing this information in advance helps prepare said witnesses in advance, allowing them to anticipate based on past behavior, how an attorney will approach a future deposition and which what exhibits.

Exemplars of embodiments of aspects of the system are depicted below.

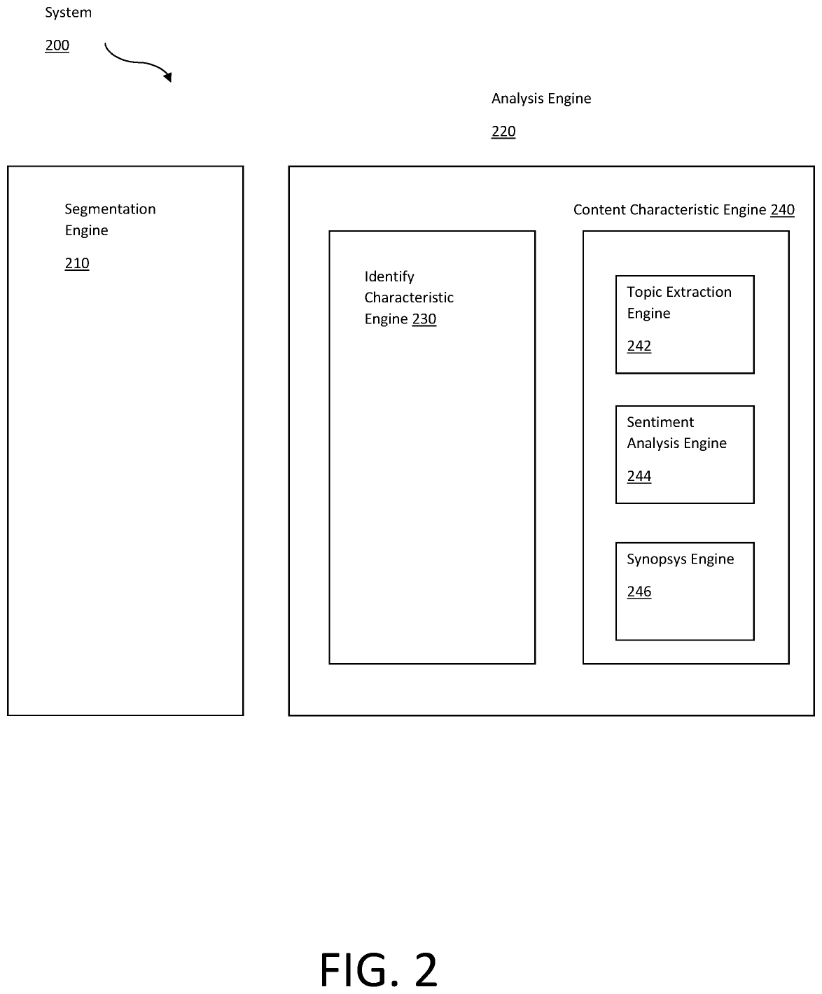

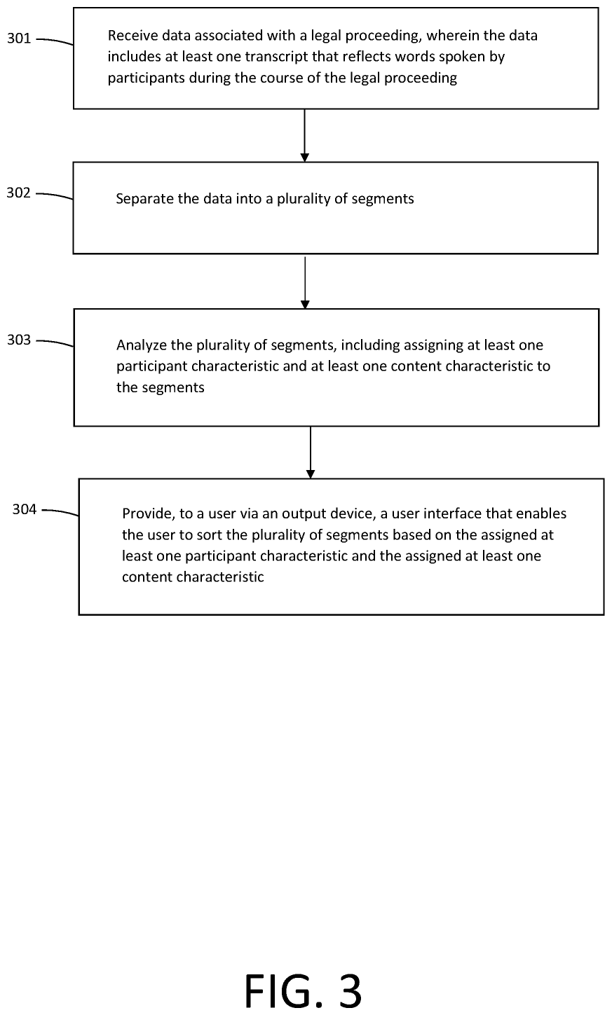

FIG. 2 is a block diagram that depicts a Legal Proceeding Analysis System 200. As shown in FIG. 1, system 200 includes a segmentation engine 210, and an analysis engine 220, the functions which are described below with reference to the flow chart depicted in FIG. 3. Analysis engine 210 includes an identity characteristics engine 230 and a content characteristics engine 240, which includes a topic extraction engine 242, a sentiment analysis engine 244, and a synopsys engine 246. Each respective “engine” depicted in FIG. 2 may be implemented via any combination of local or networked hardware or software components, for example via execution of non-transitory instructions stored on a computer readable medium such as a memory or a long-term storage device, or implemented via any form of artificial intelligence or machine learning techniques including training machine learning modules to perform the functions described herein.

FIG. 3 is a flow chart diagram that depicts one example of a method that may be performed by system 200 depicted in FIG. 1 according to one or more aspects of this disclosure. As shown in FIG. 3, at 301, the method includes receiving data associated with a legal proceeding. The data includes at least one transcript that reflects words spoken by participants during the course of the legal proceeding. In some examples, the data includes more than just the textual words spoken, and further includes additional information reflecting the context associated with the words spoken, such characteristics of the speakers voice (e.g., a sentiment of the speaker's voice, whether they were angry, excited, happy, worried, etc.) extracted from audio or video recordings of the proceedings.

At 302, the method further includes separating (e.g., by segmentation engine 210) the data into a plurality of segments. For example, separating the data may include separating it into segments that reflect one or more of: a question asked during the legal proceeding, an answer given in response to the question asked during the legal proceeding, an objection raised during the legal proceeding, and an argument raised during the legal proceeding. In some examples, the data is separated into a plurality of segments that represent question answer pairs, that represent both a question asked and an answer given in response to the question asked during the legal proceeding. In some examples, an objection or legal argument raised may also be associated with some of the question answer pairs.

At 303, the method further includes analyzing the plurality of segments (e.g., by analysis engine 220). Analyzing the plurality of segments includes assigning (e.g., by identity characteristic engine 230) at least one participant characteristic to the segments. For example, where the participant is an attorney participant in the legal proceeding, the identify characteristic may include one or more of: an identify of the participant, a client represented by the participant, an industry of the client represented by the participant, a law firm of the participant, whether the participant is partner, associate, or of counsel, whether the participant attended the legal proceeding in-person or remotely, wherein the participant is adverse, neutral, or aligned to a defendant associated with the legal proceeding, and/or wherein the participant is adverse, neutral, or aligned to a plaintiff associated with the legal proceeding.

As another example, where the participant is a witness participant in the legal proceeding, the identify characteristic may include: whether the participant is an expert or fact witness, an area of expertise of the participant, whether the second is a corporate witness, an employer or employers of the participant, whether the participant attended testimonial proceeding in-person or remotely, whether the participant is adverse, neutral, or favorable to a defendant associated with the legal proceeding, and/or whether the participant is adverse, neutral, or favorable to a plaintiff associated with the legal proceeding.

Analyzing the plurality of segments further includes assigning (e.g., by content characteristic engine 240) at least one content characteristic to the segments. For example, the content characteristic may include: a subject matter of statement made by the participant (e.g., by topic extraction engine 242, a sentiment associated with a statement made by the participant (e.g., by sentiment analysis engine 244), and/or a synopsys of the plurality of segments (e.g., by synopsis engine 246).

In some examples, where the segments represent an objection raised during the legal proceeding, the content characteristic may include: a type of objection made, a legal basis under which the objection was made, such as a statute and/or case relied on, a factual basis associated with the objection, a frequency at which the objection was made, a participant that raised the objection, and a sentiment associated with the objection.

In some examples, where the segments represent an argument raised by legal counsel as part of the legal proceeding, the content characteristic may include: a type of legal argument made, a legal basis under which the argument was made, a statute based on which the argument was made, a case based on which the argument was made, a jurisdiction of a legal authority based on which the argument was made, a factual basis associated with the argument, a frequency at which the argument was made, and/or a sentiment associated with the argument.

As shown in FIG. 3, at 304, the method further includes providing, to a user via an output device (e.g., a display, not depicted in FIG. 1), a user interface that enables the user to sort the plurality of segments based on the assigned at least one participant characteristic and the assigned at least one content characteristic. In some examples, providing the user interface includes enabling a user to select at least one participant characteristic and/or at least one content characteristic by which to sort the segments reflecting the data associated with the legal proceeding; and graphically depicting a density map reflecting a frequency of the selected at least one participant characteristic and/or at least one content characteristic. In some examples, providing the user interface further includes enabling a user to quickly access the segments associated with the selected at least one participant characteristic and/or at least one content characteristic by selecting one or more characteristics graphically displayed via the density map.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

What is claimed is:

1. A method, comprising:
receiving data associated with a legal proceeding, wherein the data includes at least one transcript that reflects words spoken by participants during the course of the legal proceeding;
separating the data into a plurality of segments that each comprise data associated with at least one of:
a question asked during the legal proceeding;
an answer given in response to the question asked during the legal proceeding;
an objection raised during the legal proceeding; and
an argument raised during the legal proceeding;
analyzing the plurality of segments, comprising:
assigning at least one participant characteristic to the segments based on an identity of the a participant associated with the segment; and
assigning at least one content characteristic to the segments based on the content associated with the segment;
providing, to a user via an output device, a user interface that enables the user to sort the plurality of segments based on the assigned at least one participant characteristic and the assigned at least one content characteristic.

2. The method of claim 1, wherein receiving the data includes receiving data associated with a plurality of legal proceedings, and wherein the user interface further enables the user to sort the plurality of segments based on the assigned at least one participant characteristic and the assigned at least one content characteristic across the plurality of legal proceedings.

3. The method of claim 1, wherein assigning at least one participant characteristic comprises assigning an adversity status to a participant associated with each segment that indicates whether the participant is adverse, neutral, or aligned.

4. The method of claim 1, wherein assigning the at least one participant characteristic comprises identifying whether the participant is an attorney or a witness.

5. The method of claim 1, further comprising assigning at least one identity characteristic selected from the group consisting of:
an identify of the participant;
a client represented by the participant;
an industry of the client represented by the participant;
a law firm of the participant; and
whether the participant is partner, associate, or of counsel;
whether the participant attended the legal proceeding in-person or remotely;
wherein the participant is adverse, neutral, or aligned to a defendant associated with the legal proceeding; and
wherein the participant is adverse, neutral, or aligned to a plaintiff associated with the legal proceeding.

6. The method of claim 1, further comprising assigning at least one identity characteristic selected from the group consisting of:
whether the participant is an expert or fact witness;
an area of expertise of the participant;
whether the participant is a corporate witness;
an employer or employers of the participant;
whether the participant attended testimonial proceeding in-person or remotely;
whether the participant is adverse, neutral, or favorable to a defendant associated with the legal proceeding; and
whether the participant is adverse, neutral, or favorable to a plaintiff associated with the legal proceeding.

7. The method of claim 1, wherein further comprising assigning at least one content characteristic selected from the group consisting of:
a subject matter of statement made by the participant;
a sentiment associated with a statement made by the participant;
a length of a statement made by the participant;
words or phrases used by the participant;
a frequency of words used by the participant.

8. The method of claim 1, wherein providing, to the user via the output device, the user interface comprises:
enabling a user to select at least one participant characteristic and/or at least one content characteristic by which to sort the segments reflecting the data associated with the legal proceeding; and graphically depicting a density map reflecting a frequency of the selected at least one participant characteristic and/or at least one content characteristic.

9. The method of claim 8, wherein providing, to the user via the output device, the user interface further comprises:
enabling a user to quickly access the segments associated with the selected at least one participant characteristic and/or at least one content characteristic by selecting one or more characteristics graphically displayed via the density map.

10. The method of claim 1, wherein the separating the data into a plurality of segments that each comprise data associated with:
a question answer pair reflecting a question asked during the legal proceeding and an answer given in response to the question asked during the legal proceeding;

11. The method of claim 10, separating the data into a plurality of segments further comprises associating an objection raised with the question answer pair.

12. The method of claim 1, wherein assigning the at least one content characteristic to each of the segments further comprises assigning at least one objection characteristic selected from the group consisting of:
a type of objection made;
a legal basis under which the objection was made;
a factual basis associated with the objection;
a frequency at which the objection was made;
a participant that raised the objection; and
a sentiment associated with the objection.

13. The method of claim 1, wherein assigning the at least one content characteristic to each of the segments comprises assigning at least one argument characteristic selected from the group consisting of:
a type of legal argument made;
a legal basis under which the argument was made;
a statute based on which the argument was made;
a case based on which the argument was made;
a jurisdiction of a legal authority based on which the argument was made;
a factual basis associated with the argument;
a frequency at which the argument was made; and
a sentiment associated with the argument.

14. A system, comprising:
a segmentation engine that receives data associated with a legal proceeding, wherein the data includes at least one transcript that reflects words spoken by participants during the course of the legal proceeding and separates the data into a plurality of segments that each comprise data associated with at least one of:
a question asked during the legal proceeding;
an answer given in response to the question asked during the legal proceeding;
an objection raised during the legal proceeding; and
an argument raised during the legal proceeding;
an analysis engine that analyzes analyzing the plurality of segments and comprises:
an identity characteristic engine that assigns at least one participant characteristic to the segments based on an identity of the a participant associated with the segment; and
a content characteristic engine that assigns at least one content characteristic to the segments based on the content associated with the segment; and
a user interface that enables the user to sort the plurality of segments based on the assigned at least one participant characteristic and the assigned at least one content characteristic.

15. The system of claim 14, wherein the data is associated with a plurality of legal proceedings, and wherein the user interface enables the user to sort the plurality of segments based on the assigned at least one participant characteristic and the assigned at least one content characteristic across the plurality of legal proceedings.

16. The system of claim 14, wherein the at least one participant characteristic comprises an adversity status that indicates whether the participant is adverse, neutral, or aligned.

17. The system of claim 14, wherein the at least one participant characteristic indicates whether the participant is an attorney or a witness.

18. The system of claim 14, wherein the at least one participant characteristic includes at last one characteristic selected from the group consisting of:
an identify of the participant;
a client represented by the participant;
an industry of the client represented by the participant;
a law firm of the participant; and
whether the participant is partner, associate, or of counsel;
whether the participant attended the legal proceeding in-person or remotely;
wherein the participant is adverse, neutral, or aligned to a defendant associated with the legal proceeding; and
wherein the participant is adverse, neutral, or aligned to a plaintiff associated with the legal proceeding.

19. The system of claim 14, wherein the at least one participant characteristic includes at least one characteristic selected from the group consisting of:
whether the participant is an expert or fact witness;
an area of expertise of the participant;
whether the participant is a corporate witness;
an employer or employers of the participant;
whether the participant attended testimonial proceeding in-person or remotely;
whether the participant is adverse, neutral, or favorable to a defendant associated with the legal proceeding; and
whether the participant is adverse, neutral, or favorable to a plaintiff associated with the legal proceeding.

20. The system of claim 14, wherein the at least one content characteristic includes at least one characteristic selected from the group consisting of:
a subject matter of statement made by the participant;
a sentiment associated with a statement made by the participant;
a length of a statement made by the participant;
words or phrases used by the participant;
a frequency of words used by the participant.

21. The system of claim 14, wherein providing, to the user via the output device, the user interface comprises:
enabling a user to select at least one participant characteristic and/or at least one content characteristic by which to sort the segments reflecting the data associated with the legal proceeding; and graphically depicting a density map reflecting a frequency of the selected at least one participant characteristic and/or at least one content characteristic.

22. The system of claim 21, wherein the user interface further enables a user to quickly access the segments associated with the selected at least one participant characteristic and/or at least one content characteristic by selecting one or more characteristics graphically displayed via the density map.

23. The system of claim 14, wherein at least some of the plurality of segments comprise data associated with a question answer pair reflecting a question asked during the legal proceeding and an answer given in response to the question asked during the legal proceeding;

24. The system of claim 23, wherein at least some of the segments are associated with an objection raised with the question answer pair.

26. The system of claim 14, wherein at least some of the segments identify an objection raised during the legal proceeding, and wherein the at least one content characteristic comprises at least one characteristic selected from the group consisting of:
a type of objection made;
a legal basis under which the objection was made;
a factual basis associated with the objection;
a frequency at which the objection was made;
a participant that raised the objection; and
a sentiment associated with the objection.

27. The system of claim 14, wherein the data comprises arguments made by legal counsel as part of the legal proceeding and wherein the at least one content characteristic comprises at least one characteristic selected from the group consisting of:
a type of legal argument made;
a legal basis under which the argument was made;
a statute based on which the argument was made;
a case based on which the argument was made;
a jurisdiction of a legal authority based on which the argument was made;
a factual basis associated with the argument;
a frequency at which the argument was made; and
a sentiment associated with the argument.

28. A non-transitory computer-readable medium comprising instructions that, when executed by a processor, cause a computing device to:
receive data associated with a legal proceeding, wherein the data includes at least one transcript that reflects words spoken by participants during the course of the legal proceeding;
separate the data into a plurality of segments that each comprise data associated with at least one of:
a question asked during the legal proceeding;
an answer given in response to the question asked during the legal proceeding;
an objection raised during the legal proceeding; and
an argument raised during the legal proceeding;
analyze the plurality of segments, comprising:
assign at least one participant characteristic to the segments based on an identity of the a participant associated with the segment; and
assign at least one content characteristic to the segments based on the content associated with the segment;
provide, to a user via an output device, a user interface that enables the user to sort the plurality of segments based on the assigned at least one participant characteristic and the assigned at least one content characteristic.

29. The non-transitory computer-readable medium of claim 28, wherein the data includes data associated with a plurality of legal proceedings, and wherein the user interface further enables the user to sort the plurality of segments based on the assigned at least one participant characteristic and the assigned at least one content characteristic across the plurality of legal proceedings.

30. The non-transitory computer-readable medium of claim 28, wherein the at least one participant characteristic indicates whether the participant is adverse, neutral, or aligned.

31. The non-transitory computer-readable medium of claim 28, wherein the at least one participant characteristic identifies whether the participant is an attorney or a witness.

32. The non-transitory computer-readable medium of claim 28, wherein the at least one participant characteristic comprises assigning at least one characteristic selected from the group consisting of:
an identify of the participant;
a client represented by the participant;
an industry of the client represented by the participant;
a law firm of the participant; and
whether the participant is partner, associate, or of counsel;
whether the participant attended the legal proceeding in-person or remotely;
wherein the participant is adverse, neutral, or aligned to a defendant associated with the legal proceeding; and
wherein the participant is adverse, neutral, or aligned to a plaintiff associated with the legal proceeding.

33. The non-transitory computer-readable medium of claim 28, wherein the at least one participant characteristic comprises assigning at least one characteristic selected from the group consisting of:
whether the participant is an expert or fact witness;
an area of expertise of the participant;
whether the participant is a corporate witness;
an employer or employers of the participant;
whether the participant attended testimonial proceeding in-person or remotely;
whether the participant is adverse, neutral, or favorable to a defendant associated with the legal proceeding; and
whether the participant is adverse, neutral, or favorable to a plaintiff associated with the legal proceeding.

35. The non-transitory computer-readable medium of claim 28, wherein the at least one content characteristic comprises at least one content characteristic selected from the group consisting of:
a subject matter of statement made by the participant;
a sentiment associated with a statement made by the participant;
a length of a statement made by the participant;
words or phrases used by the participant;
a frequency of words used by the participant.

36. The non-transitory computer-readable medium of claim 28, wherein the user interface enables a user to select at least one participant characteristic and/or at least one content characteristic by which to sort the segments reflecting the data associated with the legal proceeding; and graphically depicting a density map reflecting a frequency of the selected at least one participant characteristic and/or at least one content characteristic.

37. The non-transitory computer-readable medium of claim 36, wherein the user interface enables
a user to quickly access the segments associated with the selected at least one participant characteristic and/or at least one content characteristic by selecting one or more characteristics graphically displayed via the density map.

38. The non-transitory computer-readable medium of claim 28, wherein the data segments that each comprise data associated with a question answer pair reflecting a question asked during the legal proceeding and an answer given in response to the question asked during the legal proceeding;

39. The non-transitory computer-readable medium of claim 38, wherein the segments further include an objection raised with the question answer pair.

40. The non-transitory computer-readable medium of claim 28, wherein the at least one content characteristic comprises at least one characteristic selected from the group consisting of:
a type of objection made;
a legal basis under which the objection was made;
a factual basis associated with the objection;
a frequency at which the objection was made;
a participant that raised the objection; and
a sentiment associated with the objection.

41. The non-transitory computer-readable medium of claim 28, wherein the at least one content characteristic comprises at least one argument characteristic selected from the group consisting of:
a type of legal argument made;
a legal basis under which the argument was made;
a statute based on which the argument was made;
a case based on which the argument was made;
a jurisdiction of a legal authority based on which the argument was made;
a factual basis associated with the argument;
a frequency at which the argument was made; and
a sentiment associated with the argument.
